(19) United States
(12) Patent Application Publication
(10) Pub. No.: US 2020/0409982 A1
(43) Pub. Date: Dec. 31, 2020

(54) Method And System For Hierarchical Classification Of Documents Using Class Scoring

(71) Applicant: i2k Connect, LLC., Missouri City, TX (US)

(72) Inventors: Bruce G. Buchanan, Orcas, WA (US); Reid G. Smith, Missouri City, TX (US); Joshua R. Eckroth, Deland, FL (US)

(21) Appl. No.: 16/908,005

(22) Filed: Jun. 22, 2020

Related U.S. Application Data
(60) Provisional application No. 62/866,114, filed on Jun. 25, 2019.

(51) Int. Cl. G06F 16/35; G06F 16/31; G06K 9/00; G06N 5/04

(52) U.S. Cl. CPC G06F 16/353; G06F 16/355; G06N 5/045; G06K 9/00469; G06F 16/313

(57) ABSTRACT

A method and system for hierarchically classifying text documents, using scoring and ranking. In particular, the present invention provides a system and method for classifying text documents, where terms in the document are associated with a class drawn from a taxonomy and used to calculate a score for each class. In one form, terms are captured for each class and adjustments made to compute a score to classify a document into a class. Using the scores, the top classes in a document are computed. Advantageously, the method and system can explain the classification, including why a class was not considered.

### PRIORITY CLAIM

The present application claims priority to U.S. Provisional Application No. 62/866,114 filed Jun. 25, 2019, which is incorporated by reference herein.

### BACKGROUND OF THE INVENTION

### Field of the Invention

The present invention relates to methods and systems for classifying text documents, using hierarchical scoring and ranking. In particular, the present invention provides a system and method for classifying text documents where terms in the document are associated with a class in a taxonomy comprising a hierarchy of classes and used to calculate a score for each class. The method accommodates any number of class hierarchies.

### Description of Related Art

There is a need to classify text documents using automated methods. Manual classification of documents is possible for small numbers of documents, but it is slow, inconsistent, and time-consuming. Given the dramatic growth in the volume of relevant data, many automated methods have been developed to automatically classify documents with varying success.

### BRIEF SUMMARY OF THE INVENTION

A system and method in accordance with the present invention for classifying text documents broadly includes the steps of scoring and ranking terms for a number of classes in a document and explaining the reasoning for the classification of the document.

In broad detail, a method of classifying a text document for a subject matter in accordance with the present invention first identifies top classes in one or more taxonomies by matching rules and literal terms associated with each individual class, computing document scores for each class, including a confidence factor, and computing topics for each class using the document scores. Next, the method of classifying a text document develops a reasoning for the classification of a document, including displaying the classes and confidence factor for each class separately, including listing at least some of the matched terms.

### BRIEF DESCRIPTION OF THE DRAWINGS

The following drawings form part of the present specification and are included to further demonstrate certain aspects of the present invention. The figures are not necessarily drawn to scale. The invention may be better understood by reference to one or more of these drawings in combination with the detailed description of specific embodiments presented herein.

FIG. 1 is an overview of the overall procedure in accordance with an embodiment of the present invention.

FIG. 2 is a flow diagram of a Scoring and Ranking Procedure in accordance with an embodiment of the present invention.

FIG. 3 is a display of Enriched Content, explaining where the matched terms are found in one example taken from a published document.

FIG. 4 is a display of the top classes (sometimes known as “topics”) for the same document.

FIG. 5 shows the terms found in the text for one of the top classes (ska “topics”) shown in FIG. 4.

### DETAILED DESCRIPTION OF PREFERRED EMBODIMENTS

### Definitions

Term: A word or phrase found in a document that constitutes evidence for a classification into a class. A term may be a literal phrase or a rule in a classifier that may match one or more words or phrases in a document. For example, if the literal word “oncology” is found in a document, it is evidence for the class: Industry>Health & Medicine>Therapeutic Areas>Oncology. Similarly, the phrase “three run homer” is evidence for the class Industry>Leisure & Entertainment>Sports>Baseball. Phrases are often coded in rules as regular expressions to compactly capture grammatical and semantic variations; e.g., one run homer, two run homer, three run homer which may be written in the regular expression syntax of a rule as /(one|two|three) run homer/ in which any member of the group in parentheses may match in the document.
A-list (Association List): List of rules and literal terms that constitute evidence for classifications in a specific taxonomy. The rules and literal terms in an A-list are referred to as “A-list terms.”
View (synonym for Taxonomy): A directed acyclic graph of class names arranged in general-to-specific order without presumption of independence of classes.
Zone: An isolated part of a document, such as Title, Summary, File Path, or Body.

### Principles

The procedure embodies several intuitions and assumptions. Here are some of them.
A document may be “about” several, sometimes unrelated, topics.
The views are not orthogonal. A document may be classified under several different views; e.g., a press release (identified in the Genre view) is often about a company in a specific industry (identified in the Industry view).
Classes within a view are not orthogonal either. For instance, within the Industry view a document may be about both Government (e.g., government regulations) and Energy (e.g., the upstream oil & gas industry).
Classes within a view are arranged hierarchically, even though the branches are not strictly independent.
Evidence for a subclass should also count as evidence for its parent class in the taxonomy. (Small amounts of evidence for several subclasses of the same parent indicate the document is more about the parent class than any one of the subclasses.)
Higher frequency of occurrence of terms associated with the same class is more evidence for the class. (Peripheral topics will not have as many descriptive terms as top classes (ska “topics”).)
Term occurrence in the Title, File Path, and Summary are more important than in the body. (Authors put them there to indicate the top classes (ska “topics”).)
Any number of occurrences of just one term associated with a class is insufficient evidence for that class. (Many phrases are used metaphorically by authors and should not count as evidence when they are the only evidence for the class.)
Occurrences of multiple, distinct terms count as stronger evidence than the same number of occurrences of a smaller number of terms. (Authors are likely to use a larger variety of terms related to a top class (ska “topic”) than with peripheral topics.)
The most important classes are those among all classes in all views with scores in a top cluster: When a document is very clearly about one or more strongly-indicated classes, classes with significantly less evidence can be considered as peripheral.

### Strategy

The overall strategy for classifying a document is conceptually simple: identify the “top classes” in a set of views. The steps are:
Identify the important zones of the document, currently the Title, File Path, Summary, and Body parts of the document and separate them into text.
For each view (e.g., Industry, Society of Petroleum Engineers, Genre), retrieve the terms associated with all the classes in that view. Terms are literal words, literal phrases, and rules.
Find terms in the document that are evidence for their associated classes, with their frequency of occurrence weighted according to the zone of the document in which they appear.
Calculate a score for each class for which there is evidence.
Eliminate classes whose score is below an absolute minimum or below a threshold determined as a fraction of the highest score.
Return the top classes (ska “topics”); i.e., the classes with scores in a top cluster.

### Detailed Steps and Parameters of the Procedure

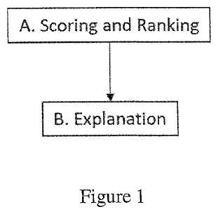

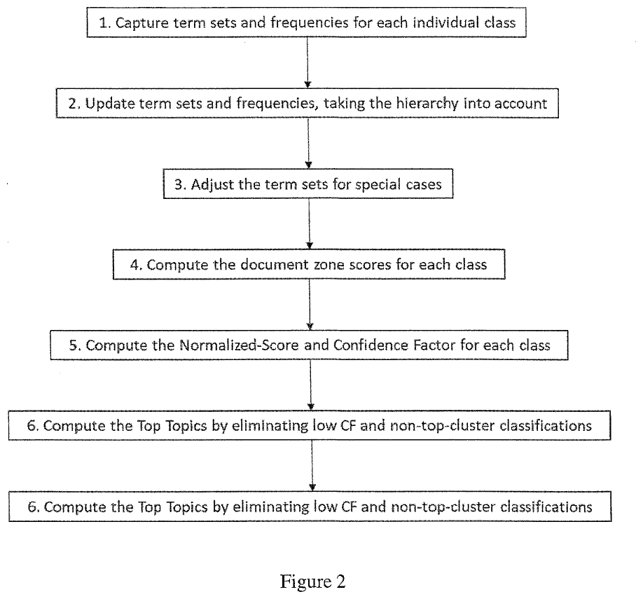

For each document, execute the following procedure for each view. For other embodiments, a user may choose to restrict the process to selected views. Turning to FIG. 1, the first general process is scoring and ranking using captured terms to compute document zone scores for each class. Using the scores, top classes (ska “topics”) for the document are determined. In the second step of FIG. 1, the method and system explains its reasoning for classification.
FIG. 2 is an overview of the Scoring and Ranking procedure of FIG. 1. The first step, “Capture term sets and frequencies for each individual class” contains the following sequence of steps.
1. Capture term sets and frequencies for each individual class

For each class C,

TC=set of A-list terms in the Title and mapped to class C

SC=set of A-list terms in the Summary and mapped to class C

BC=set of A-list terms in the Body and mapped to class C

PC=set of A-list terms in the File Path and mapped to class C

DC=set of unique A-list terms mapped to class C

NTC=#occurrences of terms in TC and mapped to class C

NSC=#occurrences of terms in SC and mapped to class C

NBC=#occurrences of terms in BC and mapped to class C

NPC=#occurrences of terms in PC and mapped to class C

NDC=#terms in DC

If NDC=1 for class C, and Unambiguous=TRUE for the single A-list term in DC, set NDC=MappingMinTaxnodeTermCount+1.

An example of an unambiguous term is “Oncology.”

Note that if MappingMinTaxnodeTermCount is large, this will have the effect of multiplying the effect of the Unambiguous term by that factor.
2. Update term sets and frequencies, taking the taxonomy into account

The second step of FIG. 2 updates term sets. Working from the deepest classes in the taxonomy up to the root, update the values of TC, SC, BC, PC, DC, NTC, NSC, NBC, NPC, and NDC for each parent class to capture contributions from its child classes. The term set for each parent class is the union of the term sets for its child classes (without duplication).

### Example

Consider this three-level taxonomy, where each class is represented by its path from the root; e.g., A>A1>A11.

Working up from A11, the term set for A1 is the union of the term sets A1, A11 and the rest of the immediate children of A1 (without duplication).

The term set for A is the union of the term sets for A, A1, and the rest of the immediate children of A (without duplication).
3. Adjust the term sets for special cases

The third step of FIG. 2 adjusts term sets as follows.

1. Do not double count terms in the Title and File Path.
If a term for class C is found in both TC and PC, remove the term from PC. (A number of news sources use the title in the file path.)

2. Eliminate low diversity classifications.
Eliminate each class C for which the following holds: the combined number of distinct terms from the body or summary is less than or equal to
MappingMinTaxnodeTermCount and both the title and filepath have no terms from the class.
MappingMinTaxnodeTermnCount is currently set to 1.
4. Compute the document zone scores for each class

The fourth step of FIG. 2 computes document zone scores. For each class.

FTC=NTC*MappingTitleWeight

FSC=NSC*MappingSummaryWeight

FBC=NBC*MappingBodyWeight*250/#words processed in the document.

FBC is a weighted term density measurement that is independent of the length of the document. 250 is the generally accepted number of words per page

FPC=NPC*MappingFilepathWeight

FDC=Min((NDC*MappingDiversityWeight)**MappingExponentialDiversityWeight,MaxDiversityWeight)

(Boost the overall score for a class exponentially (up to a limit) with the number of unique terms used as evidence for the class)

MappingTitleWeight=9

MappingSummaryWeight=5

MappingBodyWeight=1

MappingFilepathWeight=9

MappingDiversityWeight=1

ExponentialDiversityWeight=1.75

MaxDiversityWeight=25

Of course, the exact parameter values are a design choice and the current parameter values are believed to be preferable in the preferred embodiment discussed herein. ExponentialDiversityWeight addresses the problem where scores are too low for class assignments in which more than two terms appear in the Body, but the correct class assignment is not included among top classifications. This is especially noticeable when terms do not appear in Title, Path, or Summary.

Note on Regexes and Diversity: A regex match counts as one term for diversity, but every different match of that regex is counted to compute match frequency and therefore FTC, FSC, FBC, and FPC.
5. Compute the Normalized-Score and Confidence Factor for each class

The fifth step of FIG. 2 normalizes scores for each class. Normalize scores with respect to a “good enough score” for each class; i.e., a score that is good enough to classify a document into a class.

Assumptions

There is “good-enough” evidence for a class if there is at least:

one occurrence of one A-list term in the Title

three occurrences of one or more A-list terms in the Summary

average density of A-list terms per page≥1.0

(with no terms in the File Path)

Therefore, the Good-Enough-Score=25.

MappingTitleWeight*1+MappingSummaryWeight*3+MappingBodyWeight*1+0=9+(5*3)+1+0

Normalized-Score=(FTC+FSC+FBC+FPC+FDC)/25

Finally, the Confidence Factor (CF) for each Normalized Score.

CF=MIN(Normalized-Score, 1.0).

So CF=1.0 indicates high confidence that the evidence is good enough for a class.

CF<1.0 indicates proportionally less confidence

Note: There are other possibilities for CF; e.g., relative to highest Normalized-Score. We use the above equation because it reflects the confidence we have in a prediction, relative to an absolute measure of what is good enough.
6. Compute the Top classes (ska “topics”) by eliminating low CF and non-top-cluster classifications.

The sixth step of FIG. 2 computes the top topics. At this point, the system and method hereof has identified All Topics and MatchedTerms for the document

To compute the Top classes (ska “topics”)
1. Eliminate classes with Normalized-Score<MappingNormalizedThreshold. Start with MappingNormalizedThreshold=0.6.
2. At each level, eliminate each class with Normalized-Score<MappingNormalizedMultiplierThreshold*Max (all Normalized-Scores at this level) [i.e., class is not in the top cluster at this level.
3. Eliminate classes for which
   Normalized-Score/Maximum-Normalized-Score<MaxNormalizedScoreRatio.
   Start with MaxNormalizedScoreRatio=0.02
   This is intended to remove “noise” classes, where several classes have enough evidence to be assigned CF=1.0, but some have much larger Normalized-Scores.
   Note: MaxNormalizedScoreRatio applies to a single view. The scoring in each view is independent of all other views.

For a less cluttered explanation, eliminate all unnecessary intermediate (parent) nodes. Display only the parent nodes where there is a switch from “strong” evidence to “weak” evidence between the parent and the child. A classification in a view is considered to be “strong” and is emboldened in the display if CF>MappingNormalizedThreshold and CF>TopClusterThreshold*the top leaf node score in that view. In the present implementation, TopClusterThreshold=0.3.

Explanation

The last major component of the process of FIG. 1 is to explain the reasoning for the classification of a document. First, display the classes and CF's for each view separately in order of leaf node score rather than alphabetically.

In addition, the system can explain its reasoning for any classification by listing the terms that have the biggest impact. For example, for the class Motorsports in the article entitled “Qualcomm and Mercedes-AMG Petronas Motorsport Conduct Trials Utilizing 802.11ad Multi-gigabit Wi-Fi for Racecar Data Communications” (https://www.prnewswire.com/news-releases/qualcomm-and-mercedes-amg-petronas-motorsport-conduct-trials-utilizing-80211ad-multi-gigabit-wi-fi-for-racecar-data-communications-300413725.htm), the top terms (highest weighted) are: Mercedes AMG Petronas, Motorsport, Racecar.

The system can also explain why a class was not considered to be a top class by listing the topics from an individual view that were considered but for which there was insufficient evidence to include them in the top classes (ska “topics”). For example, in the above article, in the Industry view, the other classes considered were: Automobiles & Trucks, Telecommunications, Semiconductors & Electronics, Oil & Gas, News, Intellectual Property & Technology Law, Health & Medicine, and Education.

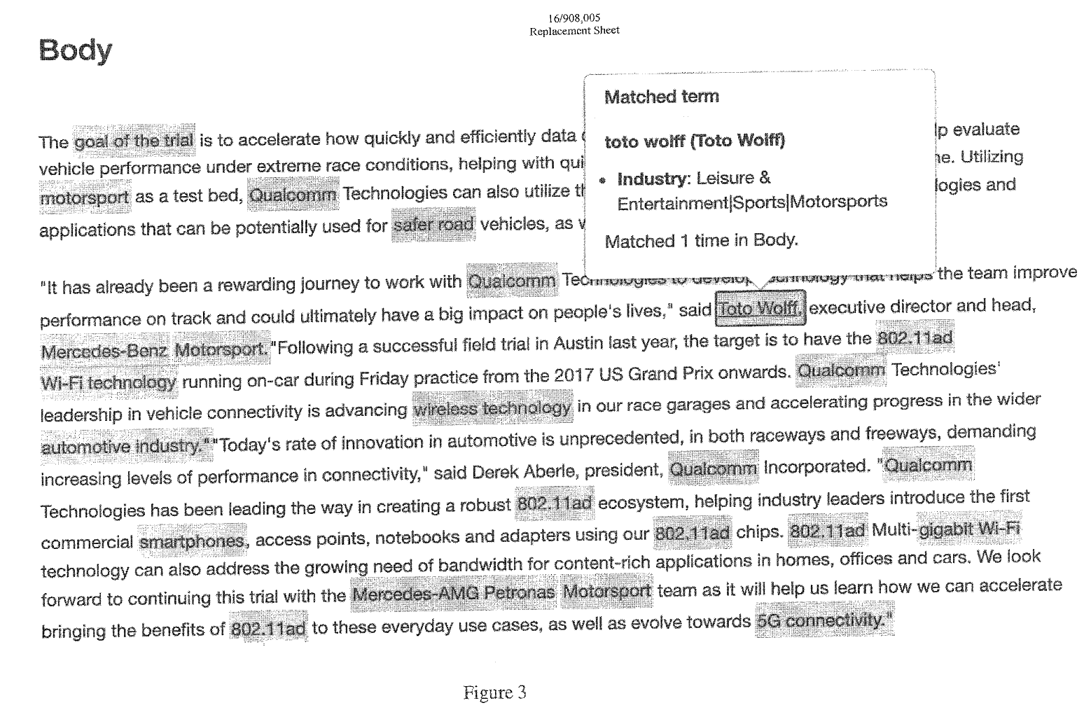

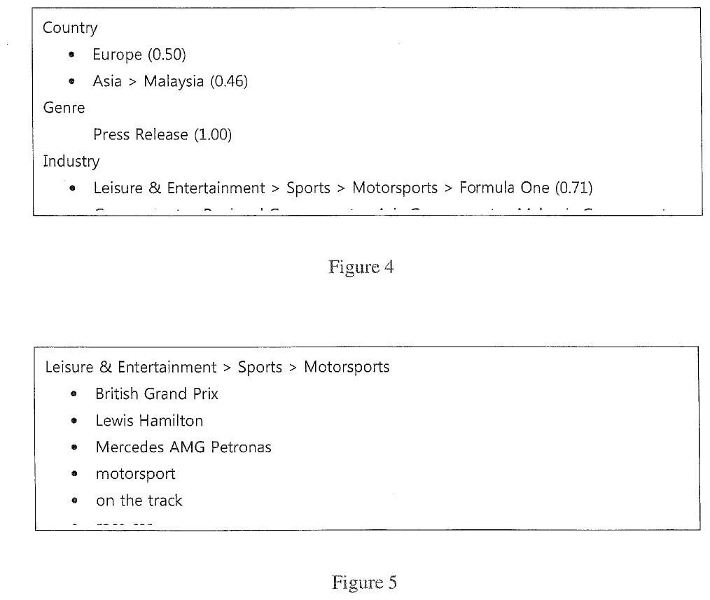

For a fuller explanation of the reasoning that leads to the classifications, the system can display the “enriched content” for a document. This display shows the text of the document, with matching terms highlighted in yellow. When the user selects a highlighted term, the system displays the classifications associated with that term. See FIG. 3, taken from the above article, which shows highlighted terms in two paragraphs of the body of this article. FIG. 4 and FIG. 5 illustrate further explanation of the basis for classification of each class in each view by showing the A-list terms found in the document.

It should be apparent from the foregoing that an invention having significant advantages has been provided. While the invention is shown in only a few of its forms, it is not just limited to those forms but is susceptible to various changes and modifications without departing from the spirit thereof.

What is claimed is:

1. A method of classifying a text document for a subject matter comprising:
a) identifying top classes in one or more taxonomies
a. capturing terms from the text document for each individual class,
b. computing document scores for each class, including a confidence factor,
c. computing classes for each taxonomy using the document scores; and
b) developing an explanation for the classification of said text document, including
displaying the classes and confidence factor for each class separately, including listing at least some of the captured terms from the text document.

2. The method of claim 1, computing document scores for each class including assigning a weight to title, summary, or term density for different zones in said text document.

3. The method of claim 1, said capturing terms from the text document including using rules as regular expressions to capture grammatical and semantic variations.

4. The method of claim 1, including capturing terms from the text document for a subclass, computing scores for said subclass, and using the scores for said subclass to contribute to a score for a parent class.

5. The method of claim 1, capturing terms including capturing contributions from one or more child subclasses of each of said individual classes.

6. The method of claim 1, identifying top classes using evidence from each individual classes, including any child or grandchild, or further desdendant subclass of each of said individual class.

7. The method of claim 1, said capturing terms from the text document including capturing frequency of occurrence of a term.

8. The method of claim 1, including combining evidence from terms including ambiguous and unambiguous terms.

9. A system of classifying a text document for a subject matter, comprising:
a) computer memory loaded with said text document and
b) one or more computer processors programmed to identify top classes in one or more taxonomies, including
a. said one or more computer processors programmed to capture terms from the text document for each individual class,
b. said one or more computer processors programmed to compute document scores for each class, including a confidence factor,
c. said one or more computer processors programmed to compute classes for each taxonomy using the document scores;
c) one or more computer processors programmed to develop an explanation for the classification of said text document, including
displaying the classes and confidence factor for each class separately, including listing at least some of the captured terms from said text document.

10. The system of claim 9, said one or more computer processors programmed to compute document scores for each class including program instructions assigning a weight to title, summary, or term density for different zones in said text document.

11. The system of claim 9, said one or more computer processors programmed to capture terms from the text document for each individual class including program instructions using rules as regular expressions to capture grammatical and semantic variations.

12. A computer implemented method for classifying a text document for a subject matter comprising:
computer readable non-transitory medium having a computer readable program stored thereon, including—
program instructions to identify top classes in one or more taxonomies,
program instructions to capture terms from said text document for each individual class,
program instructions to compute document scores for each class, including a confidence factor,
program instructions to compute classes for each taxonomy using the document scores,
program instructions to develop an explanation for the classification of said text document, and
program instructions to display the classes and confidence factor for each class separately including listing at least some of the captured terms from the text document.
